(19) United States
(12) Patent Application Publication
(10) Pub. No.: US 2011/0276657 A1
(43) Pub. Date: Nov. 10, 2011

(54) METHOD AND SYSTEM FOR THE DELIVERY OF LARGE CONTENT ASSETS TO A MOBILE DEVICE OVER A MOBILE NETWORK

(75) Inventors: Michael LeBlanc, Fredericton (CA); Jody D. Glidden, Sterling, VA (US)

(73) Assignee: CHALK MEDIA SERVICE CORP., Vancouver, BC (CA)

(21) Appl. No.: 12/809,320

(22) PCT Filed: Dec. 20, 2008
(86) PCT No.: PCT/CA08/02274

§ 371 Date: May 13, 2011

Related U.S. Application Data
(60) Provisional application No. 61/008,819, filed on Dec. 20, 2007.
(60) Provisional application No. 61/066,105, filed on Feb. 15, 2008.

(51) Int. Cl. G06F 15/16

(52) U.S. Cl. 709/219

(57) ABSTRACT

A method allows for content that exceeds the maximum size limit imposed by mobile infrastructures to be delivered to mobile devices. To accomplish this, the application splits large files into smaller chunks of data and sends the individual chunks to the mobile device, reassembling them on the device.

### REFERENCE TO RELATED APPLICATIONS

The present application claims the benefits, under 35 U.S.C. §119(e), of U.S. Provisional Application Ser. No. 61/008,819 filed Dec. 20, 2007 entitled “A Method and System for the Delivery of Large Content Assets to a Smartphone over a Mobile Network” and Ser. No. 61/66105 filed Feb. 15, 2008 entitled “Method and System for the Delivery of Large Content Assets to a Smartphone over a Mobile Network” which are incorporated herein by this reference.

### TECHNICAL FIELD

The application relates to the field of delivery of files to a mobile handheld device, such as delivery of files containing content such as graphics, audio and video to mobile devices.

### BACKGROUND

There are currently size restrictions imposed by carriers and/or mobile handheld device infrastructures that limit the transfer of large files to mobile handheld devices. Smartphones that utilize particular technology are therefore forced to adhere to this limitation. Content that exceeds the maximum allowable file size are considered undeliverable. For some systems this limit is set at 1 MB.

Within some mobile handheld device infrastructures, administrators are permitted to set the maximum allowable size of a file transfer to the mobile handheld device. While such systems no longer had a maximum size limit, the reliability of carrier networks for large files is a problem. Failures were repeatedly seen when delivering files over a certain size due to carrier coverage issues and latencies inherent in the mobile handheld device infrastructure. This results in an imposed limited size on file delivery.

In both of the above cases, timeouts occur while attempting to deliver content packages. The user can tether their device through a USB connection which may reduce the frequency of timeouts, however the size limit is still imposed. Previous methods of delivering large content assets or files to a Smartphone over a mobile network depended on a file chunk size being established before any content was published to any mobile device. If for some reason this file chunk size needed to be lowered (because, for example, the file transfer limits for the mobile handheld device infrastructure for receiving data was reduced thereby exceeding the established chunk size). then all content needed to be re-published.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic drawing illustrating the method and system of the application for splitting of a large asset file.

FIG. 2 is a schematic drawing illustrating the method and system of the application for delivery of large asset files.

FIG. 3 is a flowchart illustrating a first embodiment of the method and system of the application for delivery of large asset files.

FIG. 4 is a flowchart illustrating a second embodiment of the method and system of the application for delivery of large asset files.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In referring herein to a “mobile device”, such mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

This application works in conjunction with the application described in pending international patent application no. PCT/CA2008/000851 published Nov. 13, 2008 entitled, “Method and System for Pushing Content to Mobile Devices” which is incorporated herein by reference.

### Creating Content and Delivering to Users

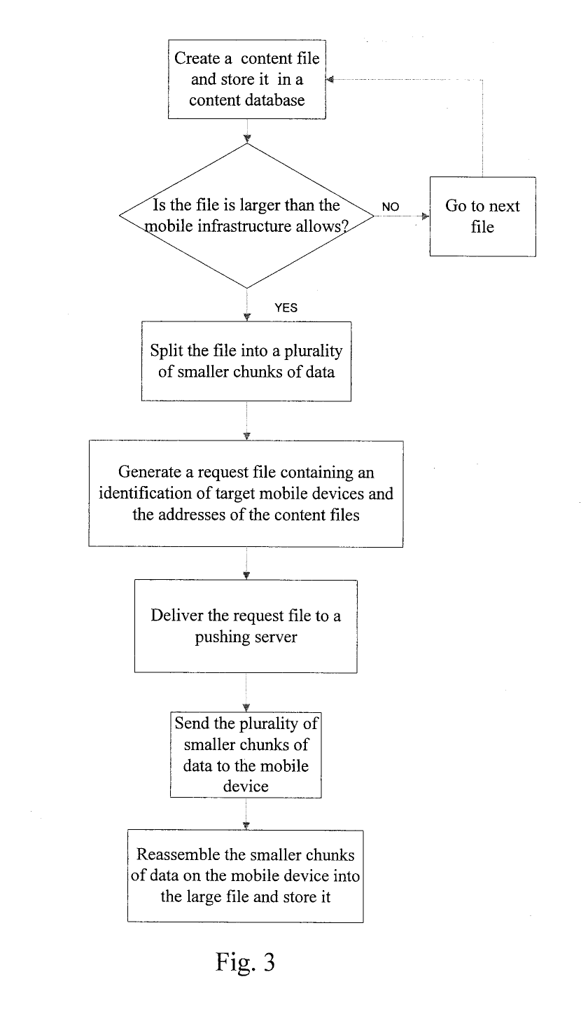

A first embodiment of the application is shown in FIG. 3. The author uses the Content Authoring and Publishing System—100 to create, publish and centrally store new content formatted for mobile devices. Content can be described as one or more media types that when combined create a document or a content package. This package can have text, images, video and audio. When content requires the addition of a large asset file, such as a video, the user simply adds the file from the Digital Asset Library—110.

Content created to be centrally stored in the central content storage can originate from any authoring platform that allows the insertion of media assets such as video or audio. Alternatively in another embodiment any large file could be added to the content package to be stored centrally. It is the central storage in the digital asset library that triggers the operations required to prepare the large file for delivery.

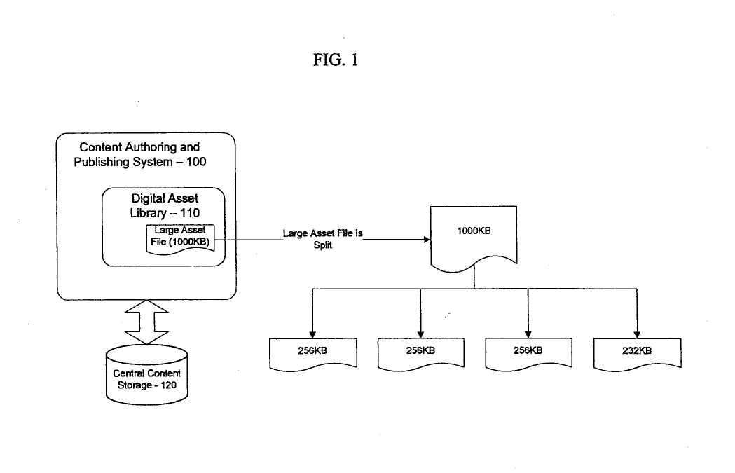

When a user adds a file to the Digital Asset Library, the system compares the size of the file with the chunk size configuration setting. If the file size exceeds the chunk size configuration setting, the file is split into smaller chunks. The splitting of the file into smaller chunks or files can result in any number of files as long as any single file does not exceed the established maximum chunk size. The creation of these files can happen in any sequence. For example in the current embodiment, if the maximum chunk size is set at 256 KB and a 1000 KB file is saved, the system will create four files, as shown in FIG. 1. The first three files are 256 KB and the final one will contain the remaining 232 KB. This is all done internally by the application. To the user creating content, this will appear as one file.

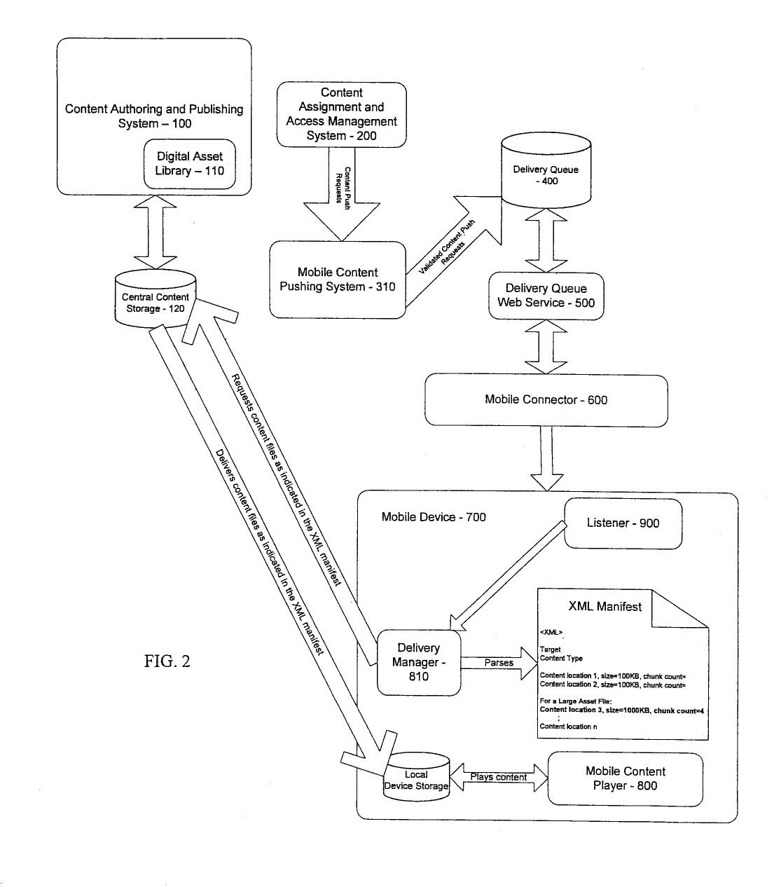

When the content has been created it can be assigned to users for consumption using the Content Assignment and Access Management—200 functionality. This component makes a request to the Mobile Content Pushing System—310 to send the content to the user's mobile device. This request is an XML document that contains all of the details of the content being pushed, including any assets, and target user information so the push can be directed to individual users. Large asset files are listed as a single file with an associated chunk count in this XML manifest. See FIG. 2.

Alternatively embodiments could have the manifest implemented in other markup languages other than XML or in some other electronic file formats. The XML manifest is sent to the Delivery Queue—400 where the Delivery Queue Web Service—500 picks up the request. The Delivery Queue Web Service—500 component listens for requests made by the Mobile Connector—600. These are requests to determine if there are items on the queue that the Mobile Connector is able to extract. If an item is found on the queue the Mobile Connector retrieves the queued item.

### Delivering Content to the Mobile Device

When the Mobile Connector—600 retrieves an XML file from the Web service, it passes it to the Mobile Device—700. The Listener—900 on the Mobile Device—700 passes the XML file (manifest) to the Delivery Manager—810. The Delivery Manager—810 extracts each content URL from the XML manifest and retrieves that piece of content from the Central Content Storage—120 on the Mobile chalkboard Server. This content is delivered through the mobile handheld device infrastructure for sending and receiving data which then pushes it to the user's device.

When a large asset file is part of the content package, it appears in the XML manifest as a single file with an associated chunk count. These chunks are received sequentially using HTTP Get Requests (“Pull”) and reassembled on the Mobile Content Player—800. Each of the chunks that comprise a large asset file is appended to the others as they are delivered to the mobile handheld device. Alternatively the chunks can be received in any order as long as they are assembled in the proper order on the mobile handheld device

### Handling Failures

For large asset files, if the delivery of any chunk fails, a retry process is initiated by the Delivery Manager—810 built into the Mobile Content Player. Upon delivery failure, the delivery process stops and waits for a preset amount of time to elapse. This duration time is configurable.

When the retry time has elapsed, the Delivery Manager initiates the pull mechanism again. The delivery process continues beginning with the failed asset chunk. The delivery of large asset files can be cancelled. If delivery fails again, the Delivery Manager again waits for the amount of time specified as the retry duration time. This retry process continues until either the content is delivered or the preset, configurable number of retries is reached and is considered a failure to deliver. If an asset could not be delivered, the Delivery Manager cleans up any chunks of that asset that were pulled to Mobile Content Player to minimize memory usage. All attempts to deliver content for large asset files are logged regardless of whether or not the delivery was a success or failure. Once the XML manifest has been received by the Mobile Device, the delivery of content is tracked. This status information is communicated back to the Mobile Content Delivery System from the Delivery Manager. The status of the content's consumption by the user is also tracked and reported (e.g. Content Received, Content Viewed, Content Completed).

There are no latency issues with running the content because it is all stored locally on the mobile device. A user can view the content while going in and out of network coverage areas because the content is local to the device.

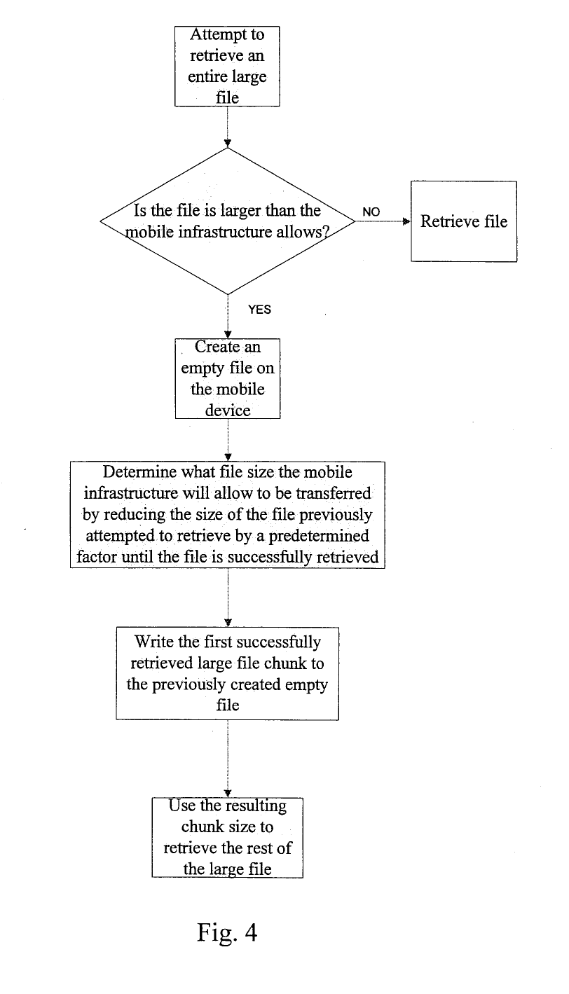

A second embodiment of the Method and System for the Delivery of Large Content Assets to a Smartphone over a Mobile Network is shown in FIG. 4.

### Creating Content and Delivering to Users

As described above, an author first uses the Content Authoring and Publishing System—100 to create, publish and centrally store new content formatted for mobile devices. When the content has been created it can be assigned to users for consumption using the Content Assignment and Access Management—200 functionality. This component makes a request to the Mobile Content Pushing System—310 to send the content to the user's mobile device. This request is an XML document that contains all of the details of the content being delivered, including any assets, and target user information so the delivery can be directed to individual users. The XML manifest is sent to the Delivery Queue—400 where the Delivery Queue Web Service—500 picks up the request. The Delivery Queue Web Service—500 component listens for requests made by the Mobile Connector—600. These are requests to determine if there are items on the queue that the Mobile Connector—600 is able to extract. If an item is found on the queue the Mobile Connector—600 retrieves the queued item.

### Delivering Content to the Mobile Device

When the Mobile Connector—600 retrieves an XML file from the Web service—500, it passes it to the Mobile Device—700. The Listener—900 on the Mobile Device—700 passes the XML file (manifest) to the Delivery Manager—810. The Delivery Manager—810 extracts each content URL from the XML manifest and retrieves that piece of content from the Central Content Storage—120 on the Mobile chalkboard Server. When a large asset file is part of the content package, the Delivery Manager—810 first attempts to download the entire asset file. If it is larger than the mobile infrastructure allows then an error will occur and Delivery Manager—810 will determine that it needs to bring down the file in smaller chunks. At this point the Delivery Manager—810 creates an empty file on the mobile device 700 to store the large asset.

Logic built into the Delivery Manager—810 allows it to determine what asset size the mobile infrastructure will allow to be transferred. It does this by reducing the previously failed attempt to retrieve a large asset by some factor (in a preferred version this is ½) until it is successful. The resulting size (called chunk size) is then used to retrieve the rest of the large asset. The Delivery Manager—810 writes the first successfully retrieved large asset chunk to the previously created empty file. It then requests the next chunk of the large asset by using the initial chunk size as an offset to the large asset file stored in the Central Content Storage—120. This is accomplished via an HTTP request to the large asset file with an offset as well as a file size specified. In this case the file size is always the chunk size and the offset keeps growing.

These chunks of data are received sequentially using HTTP Get Requests (“Pull”) and are appended to the newly created file on the Mobile Device—700 until all bytes are received. At this point, the file is closed and the Delivery Manager—810 continues to extracts the remaining content listed in the XML manifest. When all of the content in a content package has been delivered to the Local Device Storage—820 on the Mobile Device—700, it is available to be rendered to the user by the Mobile Content Player—800.

Other implementations may utilize other protocols such as HTTPS or lower Level protocols such as TCP/IP to retrieve the file segments from the central storage. These protocols would need to support the retrieval of a specific file segment based on a starting position and a length. HTTP provides this capability as part of its standard implementation. It is possible that another protocol could be created/altered to accommodate this file segment retrieval requirement as well. Also the file segments can be retrieved out of sequence as long as they are all retrieved. This would be useful in a multi threaded mobile player where each thread is spawned to retrieve its own file segment.

### Handling Failures

For large asset files, if the delivery of any chunk of data fails, a retry process is initiated by the Delivery Manager—810 built into the Mobile Content Player—800. Upon delivery failure, the delivery process stops and waits for a preset amount of time to elapse. This duration time is configurable. When the retry time has elapsed, the Delivery Manager—810 initiates the pull mechanism again. The delivery process continues beginning with the failed asset data chunk. The delivery of large asset files can be cancelled. If delivery fails again, the Delivery Manager—810 again waits for the amount of time specified as the retry duration time. This retry process continues until either the content is delivered or the preset, configurable number of retries is reached and is considered a failure to deliver. If an asset could not be delivered, the Delivery Manager—810 cleans up any chunks of data of that asset that were pulled to Mobile Content Player—800 to minimize memory usage. All attempts to deliver content for large asset files are logged regardless of whether or not the delivery was a success or failure.

### Applications of the Technology

This technology can be used to deliver any large asset files to a mobile device. These files can be media files, such as audio, video, animations or images. Practical applications of this application include:
Training systems where courses are pushed to mobile users and groups
News readers through an RSS feed
Mapping applications and satellite imagery
Sending video and audio files
Sending applications and data files to the mobile device
Podcast subscriptions.

While a number of exemplary aspects and embodiments have been discussed above, those of skill in the art will recognize certain modifications, permutations, additions and sub-combinations thereof. It is therefore intended that the application be interpreted to include all such modifications, permutations, additions and sub-combinations as are within its true spirit and scope.

What is claimed is:

1. A method of delivering a large file to a mobile device over a computer network, comprising:
i) creating one or a plurality of content files and storing said one or plurality of content files in a content database accessible to said computer network;
ii) if a content file exceeds a maximum file size, splitting said file into a plurality of smaller chunks of data;
iii) generating a request file containing an identification of said target mobile devices and the addresses of said content files;
iv) delivering said request file to a pushing server;
v) sending said plurality of smaller chunks of data to the mobile device; and
vi) reassembling said plurality of smaller chunks of data on the mobile device into said large file and storing said large file in data storage means in said one or more target mobile devices.

2. The method of claim 1 wherein said request file is an XML file.

3. The method of claim 1 wherein said sending step is done by said pushing server sending the addresses of said content files to the infrastructure for said mobile devices which retrieves said content files from said content database and sends said content files to data storage means in said target mobile devices.

4. The method of claim 1 wherein said sending step is done by said pushing server receiving said request and retrieving said content files from said content database and sending said selected content files to data storage means in said target mobile devices via the infrastructure for said mobile devices.

5. The method of claim 1 wherein said files are selected from the group consisting of audio, video, animations and images.

6. The method of claim 1 wherein for large files, if the delivery of any chunk of data fails, a retry process is initiated.

7. The method of claim 6 wherein upon delivery failure, the delivery process stops and waits for a preset amount of time to elapse; when the retry time has elapsed, initiating the pull mechanism again; if delivery fails again, again waiting for the amount of time specified as the retry duration time; continuing the process until either the content is delivered or a predetermined number of retries is reached.

8. A method of delivering a large file to a mobile device over a computer network, comprising:
i) first attempting to retrieve the entire large file;
ii) if said large file is larger than the mobile infrastructure allows, creating an empty file on the mobile device;
iii) determining what file size the mobile infrastructure will allow to be transferred by reducing the size of the file previously attempted to retrieve by a predetermined factor until the file is successfully retrieved;
iv) writing the first successfully retrieved large file chunk to the previously created empty file;
v) using the resulting chunk size to retrieve the rest of the large file.

9. The method of claim 8 wherein said predetermined factor is ½.

10. The method of claim 8 wherein each consecutive chunk of the large file is obtained by using the initial chunk size as an offset to the large file via an HTTP request to the large asset file with an offset as well as a file size specified.

11. The method of claim 8 wherein said chunks of data are received sequentially using HTTP requests and are appended to the newly created file on the mobile device until all bytes are received.

12. The method of claim 8 wherein for large files, if the delivery of any chunk of data fails, a retry process is initiated.

13. The method of claim 12 wherein upon delivery failure, the delivery process stops and waits for a preset amount of time to elapse; when the retry time has elapsed, initiating the pull mechanism again; if delivery fails again, again waiting for the amount of time specified as the retry duration time; continuing the process until either the content is delivered or a predetermined number of retries is reached.

14. The method of claim 8 wherein said retrieving steps are done by a delivery server sending the addresses of content files to the infrastructure for said mobile devices which retrieves said content files from a content database and sends said content files to data storage means in said target mobile devices.

15. The method of claim 8 wherein said retrieving steps are done by a delivery server receiving a request file and retrieving content files from a content database and sending said content files to data storage means in said target mobile devices via the infrastructure for said mobile devices.

16. The method of claim 8 wherein a delivery queue is formed at a delivery server to communicate with connecting server means communicating with the infrastructure for said mobile devices.

17. The method of claim 15 wherein said request file is an XML file.

18. A computer readable storage medium having program code stored thereon, wherein the program code, when executed by a computer, performs the following steps to deliver a large file to a mobile device over a computer network:
i) creating one or a plurality of content files and storing said one or plurality of content files in a content database accessible to said computer network;
ii) if a content file exceeds a maximum file size, splitting said file into a plurality of smaller chunks of data;
iii) generating a request file containing an identification of said target mobile devices and the addresses of said content files;
iv) delivering said request file to a pushing server;
v) sending said plurality of smaller chunks of data to the mobile device; and
vi) reassembling said plurality of smaller chunks of data on the mobile device into said large file and storing said large file in data storage means in said one or more target mobile devices.

19. A computer readable storage medium having program code stored thereon, wherein the program code, when executed by a computer, performs the following steps to deliver a large file to a mobile device over a computer network:
i) first attempting to retrieve the entire large file;
ii) if said large file is larger than the mobile infrastructure allows, creating an empty file on the mobile device;
iii) determining what file size the mobile infrastructure will allow to be transferred by reducing the size of the file previously attempted to retrieve by a predetermined factor until the file is successfully retrieved;
iv) writing the first successfully retrieved large file chunk to the previously created empty file;
v) using the resulting chunk size to retrieve the rest of the large file.

20. A system for delivering a large file to a mobile device over a computer network, comprising:
i) computer-implemented means for authoring and publishing content;
ii) data storage means for storing said content;
iii) computer-implemented means for preparing a content delivery request and delivering said request to a mobile device;
iv) computer-implemented means for retrieving content from said data storage based on said request and storing said content on a local storage of said mobile device;
wherein if a content file exceeds a maximum file size, said file is split into a plurality of smaller chunks of data, said request file contains an identification of said target mobile devices and the addresses of said content files, said plurality of smaller chunks of data are sent to the mobile device; and
said plurality of smaller chunks of data are reassembled on the mobile device into said large file and said large file is stored in said local storage on said mobile device.

21. The system of claim 20 wherein said request file is an XML file.

22. The system of claim 20 wherein said delivery is done by a pushing server sending the addresses of said content file to the infrastructure for said mobile devices which retrieves said content file from said content database and sends said content file to said local storage means in said mobile device.

23. The system of claim 20 wherein said delivery is done by a pushing server receiving said request and retrieving said content file from said content database and sending said selected content file to said local storage means in said mobile device via the infrastructure for said mobile device.

24. A system for delivering a large file to a mobile device over a computer network, comprising:
i) computer-implemented means for authoring and publishing content;
ii) data storage means for storing said content;
iii) computer-implemented means for preparing a content delivery request and delivering said request to a mobile device;
iv) computer-implemented means for retrieving content from said data storage based on said request and storing said content on a local storage of said mobile device;
wherein said computer-implemented means for retrieving content first attempts to retrieve the entire large file, and if said large file is larger than the mobile infrastructure allows, creates an empty file on the mobile device, determines what file size the mobile infrastructure will allow to be transferred by reducing the size of the file previously attempted to retrieve by a predetermined factor until the file is successfully retrieved, writes the first successfully retrieved large file chunk to the previously created empty file, and uses the resulting chunk size to retrieve the rest of the large file.

25. The system of claim 24 wherein said request file is an XML file.

26. The system of claim 24 wherein said delivery is done by a pushing server sending the addresses of said content file to the infrastructure for said mobile devices which retrieves said content file from said content database and sends said content file to said local storage means in said mobile device.

27. The system of claim 24 wherein said delivery is done by a pushing server receiving said request and retrieving said content file from said content database and sending said selected content file to said local storage means in said mobile device via the infrastructure for said mobile device.
